(19) United States
(12) Patent Application Publication
(10) Pub. No.: US 2011/0204239 A1
(43) Pub. Date: Aug. 25, 2011

(54) Radiation detection device

(75) Inventors: Futoshi Yoshida, Kanagawa-ken (JP); Yuusuke Kitagawa, Kanagawa-ken (JP); Toshiharu Kuwae, Kanagawa-ken (JP); Koichi Mizuno, Kanagawa-ken (JP)

(73) Assignee: FUJIFILM Corporation, Tokyo (JP)

(21) Appl. No.: 12/929,062

(22) Filed: Dec. 28, 2010

(30) Foreign Application Priority Data
Feb. 24, 2010 (JP) 038920/2010
Nov. 2, 2010 (JP) 245815/2010

(51) Int. Cl. G01T 1/20; G01T 1/24

(52) U.S. Cl. 250/361 R; 250/370.08

(57) ABSTRACT

A radiation detection device, which includes an imaging board for detecting radiation transmitted through a subject to obtain a radiographic image of the subject, is provided with a heat dissipating member disposed on a radiation receiving side of the imaging board.

### BACKGROUND OF THE INVENTION

1. Field of the Invention

The present invention relates to a radiation detection device, such as an electronic cassette, for taking a radiographic image of a subject.

2. Description of the Related Art

Conventionally, various types of radiation detectors (so-called “flat panel detectors”, which are hereinafter referred to as “FPDs”), which record a radiographic image of a subject formed by radiation transmitted through the subject, have been proposed and reduced into practice in the medical field, etc. An example of such a FPD is a FPD using a semiconductor, such as amorphous selenium, which generates an electric charge when exposed to radiation. As this type of FPD, those of so-called optical reading system and of TFT reading system have been proposed. Further, as FPDs of the TFT reading system, direct-type FPDs, which directly convert the radiation into an electric charge, and indirect-type FPDs, which once convert the radiation into light, and then convert the light into an electric signal, have been proposed.

The direct-type FPD is formed by an imaging board, such as a TFT panel, which includes a photoconductive film, such as amorphous selenium, a capacitor and a TFT (Thin Film Transistor) serving as a switching element mounted thereon. When radiation, such as an x-ray, is applied to the direct-type FPD, electron-hole pairs (e-h pairs) generate from the photoconductive film. The electron-hole pairs are stored in the capacitor, and the electric charge stored in the capacitor is read out as an electric signal via the TFT.

On the other hand, the indirect-type FPD is formed by a scintillator layer made of a fluorescent material and an imaging board including a photodiode, a capacitor, a TFT panel, etc., mounted thereon. When radiation is applied to the indirect-type FPD, the scintillator layer emits fluorescence. The fluorescence emitted by the scintillator layer is subjected to photoelectric conversion by the photodiode and stored in the capacitor. Then, the electric charge stored in the capacitor is read out as an electric signal via the TFT.

Further, various types of electronic cassettes, which include, in a housing thereof, a FPD and an image memory serving as storage means for storing radiographic image data outputted from the FPD, have been proposed (which are hereinafter simply referred to as cassettes). Still further, among this type of cassettes, those provided with a function to send the radiographic image data detected by the FPD to a processor via wireless communication have been proposed, so that the processor applies signal processing, such as image processing, to the radiographic image data.

This type of cassette includes therein a circuit board for driving the FPD, etc. The circuit board emits heat during driving. Since characteristics of TFTs vary depending on temperature, the heat from the circuit board may generate temperature variation across the imaging board, and this temperature variation may result in density variation of radiographic images that are obtained using the cassette. Therefore, a technique has been proposed, where a heat dissipating member made of copper or aluminum, for example, is provided on a surface of the cassette opposite from the radiation receiving side thereof to dissipate the heat from the circuit board to the outside (see Japanese Unexamined Patent Publication No. 2007-289281, which will hereinafter be referred to as Patent Document 1). Further, a cassette having a surface structure including a carbon fiber reinforced plate and an aromatic polyamide fiber reinforced resin has been proposed (see Japanese Utility Model Publication No. 61 (1986)-060255, which will hereinafter be referred to as Patent Document 2).

As a heat dissipating member for use with electronic devices, a technique using a graphite sheet has been proposed (see Japanese Unexamined Patent Publication No. 2007-207800, which will hereinafter be referred to as Patent Document 3). The graphite sheet is produced by mixing a graphite powder with a binder resin and forming the mixture into a sheet, or by rolling an expanded graphite into a sheet. The graphite sheet has better heat conductivity, is lighter and more flexible than metal plates, and therefore is expected to be used as a heat-conductive material in electronic devices, apparatuses and equipment.

The cassette needs to be made thin to be loaded in an imaging table, or the like. Therefore, the imaging board of the FPD is disposed in the vicinity of the radiation receiving surface of the cassette. During imaging using the cassette, the subject contacts the radiation receiving surface of the cassette. Therefore, the body temperature of the subject is conducted to the TFT on the imaging board via the radiation receiving surface. Further, when the operator handles the cassette, the operator may touch the radiation receiving surface of the cassette. In this case, the body temperature of the operator is conducted to the TFT via the radiation receiving surface. As a result, temperature variation is generated across the TFT, and radiographic images obtained by the imaging may have density variation due to the temperature variation. Although such density variation can be eliminated by correcting image data of the radiographic images, the correction may decrease the dynamic range of the radiographic images. Further, frequent correction may impair operational performance.

In the technique disclosed in Patent Document 1, the heat dissipating member is provided on the surface of the cassette opposite from the radiation receiving side thereof. Therefore, it is impossible to eliminate the temperature variation due to the body temperature of the subject or operator. The technique disclosed in Patent Document 2 is directed to reinforcing the surface of the cassette, and the heat due to the body temperature of the subject or operator is conducted to the imaging board. The technique disclosed in Patent Document 3 uses the graphite sheet as the heat dissipating member; however, the technique disclosed in Patent Document 3 is directed to improving the heat conductivity of electronic devices in general, and does not resolve the problem of conduction of the body temperature of the subject or operator, which is unique to the cassettes used for taking radiographic images.

### SUMMARY OF THE INVENTION

In view of the above-described circumstances, the present invention is directed to preventing temperature variation across an imaging board, such as a TFT panel, due to heat conducted from a radiation receiving side of a radiation detection device, such as a cassette.

An aspect of the radiation detection device according to the invention is a radiation detection device including an imaging board for detecting radiation transmitted through a subject to obtain a radiographic image of the subject, the device including:

a heat dissipating member disposed on a radiation receiving side of the imaging board.

The heat dissipating member may be made of a graphite sheet or a metal having high heat dissipation capability, such as copper or aluminum.

In the radiation detection device according to the invention, the heat dissipating member may have a size larger than a size of an imaging area for taking the radiographic image of the imaging board.

The radiation detection device according to the invention may further include a sheet member disposed on the radiation receiving side of the imaging board. The sheet member may be made of a material having lower heat conductivity than that of the heat dissipating member.

In this case, a surface of the sheet member on the radiation receiving side may be matted.

In the radiation detection device according to the invention, the heat dissipating member may have a radiation absorptance of not more than 1% with respect to the radiation.

In the radiation detection device according to the invention, heat conductivity in a direction parallel to a surface of the heat dissipating member may be higher than heat conductivity in a direction perpendicular to the surface.

In the radiation detection device according to the invention, the heat dissipating member may be formed by a plurality of heat dissipating members, and each of the heat dissipating members may have portions overlapping with the other heat dissipating members.

In this case, the overlapping portions of the heat dissipating members may be provided with a uniform thickness.

The radiation detection device according to the invention may further include a scintillator disposed on a side of the imaging board opposite from the radiation receiving side, the scintillator emitting fluorescent when the radiation is applied thereto.

The radiation detection device according to the invention may further include a platen disposed on the radiation receiving side, wherein the imaging board is disposed in close contact with the platen.

According to the invention, the heat dissipating member is disposed on the radiation receiving side of the imaging board. Therefore, the body temperature of the subject or operator on the radiation receiving side of the imaging board is dissipated by the heat dissipating member. Thus, no temperature variation is generated across the imaging board, thereby preventing density variation of radiographic images due to heat conducted from the radiation receiving side.

However, although the heat on the radiation receiving side is dissipated by the heat dissipating member, there is no escape for the heat at end portions of the heat dissipating member, and the heat staying there may cause density variation of the radiographic images. By providing the heat dissipating member with a size larger than the size of the imaging area for taking a radiographic image of the imaging board, the end portions of the heat dissipating member are out of the imaging area. Thus, density variation of the radiographic images due to the heat staying at the end portions of the heat dissipating member can be prevented.

Further, by providing the sheet member on the radiation receiving side of the imaging board, and forming the sheet member with a material having lower heat conductivity than that of the heat dissipating member, the sheet member serves to reduce conduction of the heat from the radiation receiving side to the heat dissipating member. Therefore, even when the subject contacts the sheet member for a long time, rapid increase of the temperature at a contact area between the subject and the heat dissipating member can be prevented. As a result, the temperature variation of the imaging board can be prevented more reliably.

Still further, by matting the surface of the sheet member on the radiation receiving side, the contact area between the sheet member and the subject or operator decreases. This reduces conduction of the body temperature of the subject or operator to the sheet member, and in turn, to the heat dissipating member. As a result, the temperature variation of the imaging board can be prevented more reliably.

Yet further, by providing the heat dissipating member with a radiation absorptance of not more than 1%, reduction of the amount of radiation that is transmitted from the radiation receiving side to the rear side of the heat dissipating member during imaging can be prevented.

Further, by providing higher heat conductivity in a direction parallel to the surface of the heat dissipating member than heat conductivity in a direction perpendicular to the surface, the heat on the radiation receiving side more easily dissipates in the direction parallel to surface of the heat dissipating member. Thus, the temperature variation across the imaging board can be prevented more reliably.

Since it is difficult to produce a large-size heat dissipating member, in particular, a graphite sheet, commercially available sheets have a relatively small size. By forming the heat dissipating member with a plurality of heat dissipating members, where each heat dissipating member has portions overlapping with the other heat dissipating members, the heat dissipating member can be manufactured less expensively while maintaining heat dissipation capability in the direction along the surface of the heat dissipating member.

In this case, by providing the overlapping portions of the heat dissipating members with a uniform thickness, partial increase of the thickness of the heat dissipating member can be prevented.

Further, in the case where the scintillator is disposed on the radiation receiving side of the imaging board, the presence of the scintillator serves to reduce conduction of the body temperature of the subject or operator from the radiation receiving side of the imaging board to the imaging board. On the other hand, in the case of a radiation detection device having an ISS structure, where the scintillator is disposed on a side of the imaging board opposite from the radiation receiving side, the imaging board is in close contact with the platen and the scintillator is not present between the platen and the imaging board, and therefore the body temperature of the subject or operator is easily conducted to the imaging board. Therefore, in the case where the radiation detection device has the ISS structure, the temperature variation across the imaging board, which is often the case with the ISS structure, can reliably be prevented by disposing the heat dissipating member on the radiation receiving side of the imaging board.

### BRIEF DESCRIPTION OF THE DRAWINGS

FIG. 1 is a perspective view showing the appearance of a cassette, to which a radiation detection device according to an embodiment of the invention is applied,

FIG. 2 is a schematic view illustrating a position of the cassette during imaging for obtaining a radiographic image,

FIG. 3 is a partial sectional view taken along a line I-I in FIG. 1, illustrating the internal structure of the cassette according to the embodiment of the invention,

FIG. 4 is a diagram for explaining a structure of a graphite sheet,

FIG. 5 is a diagram for explaining another structure of the graphite sheet,

FIG. 6 is a partial sectional view illustrating the internal structure of a cassette according to another embodiment of the invention, and

FIG. 7 is a partial sectional view illustrating the internal structure of a cassette according to yet another embodiment of the invention.

### DESCRIPTION OF THE PREFERRED EMBODIMENTS

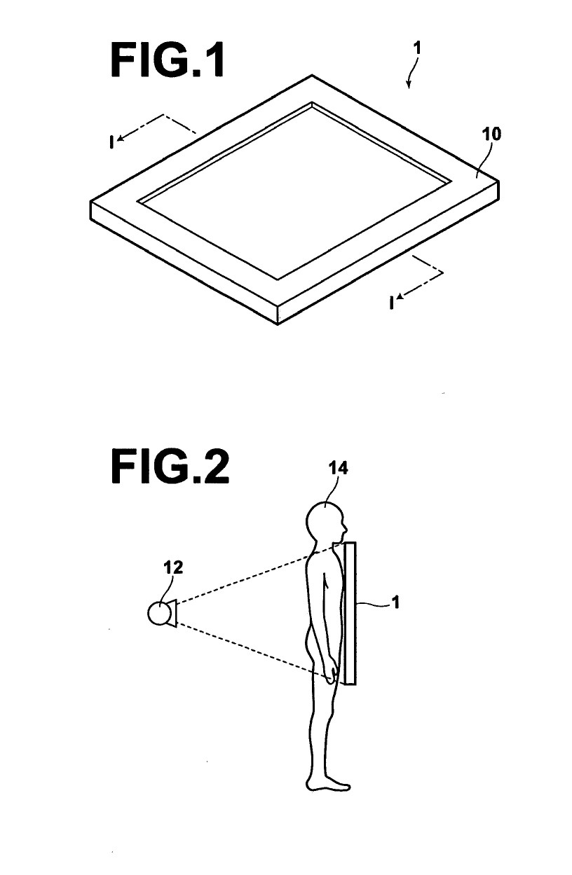

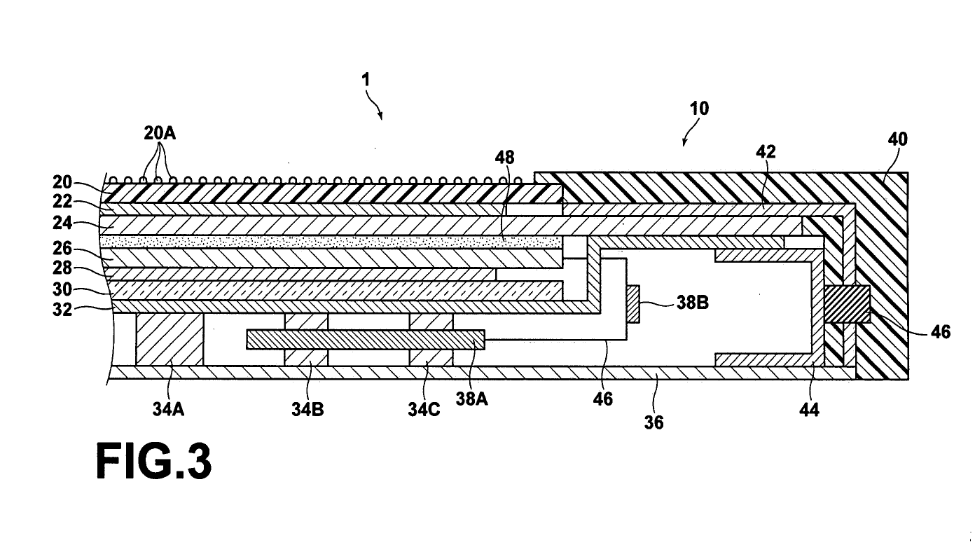

Hereinafter, embodiments of the present invention will be described with reference to the drawings. FIG. 1 is a perspective view showing the appearance of a cassette, to which a radiation detection device according to an embodiment of the invention is applied, FIG. 2 is a schematic view illustrating a position of the cassette during imaging for obtaining a radiographic image, and FIG. 3 is a partial sectional view taken along a line I-I in FIG. 1, illustrating the internal structure of the cassette according to this embodiment of the invention. The cassette 1 according to this embodiment is a portable electronic cassette, which detects radiation emitted from a radiation source and transmitted through a subject, and generates image information of an radiographic image represented by the detected radiation. As shown in FIG. 1, the cassette 1 according to this embodiment is covered with a rectangular flat housing 10, which is made of a material transmitting radiation and has a predetermined thickness.

During imaging for obtaining a radiographic image, the cassette 1 is positioned apart from a radiation source 12, such as an x-ray source, as shown in FIG. 2. In this state, radiation is emitted from the radiation source 12 toward a subject 14, and the radiation transmitted through the subject 14 enters the cassette 1 to provide a radiographic image of the subject 14.

As shown in FIG. 3, the cassette 1 includes, in the housing 10 thereof, a PC (polycarbonate) sheet 20, a graphite sheet 22, a carbon plate 24, an imaging board 26, a scintillator 28, a foam material 30 and a base plate 32 in the order from the radiation receiving side. The imaging board 26 is disposed in close contact with the carbon plate 24, which form a platen, as will be described later. The cassette 1 according to this embodiment has an ISS structure. Further, one end portions of spacers 34A to 34C are attached to the base plate 32, and the other end portions of the spacers 34A to 34C are attached to a back rid 36, which forms a surface of the cassette 1 opposite from the radiation receiving side. A space is formed by the spacers 34A to 34C between the base plate 32 and the back rid 36. In this space, circuit boards 38A and 38B for driving the cassette 1 are disposed. It should be noted that the thicknesses of the elements shown in FIG. 3, which are disposed in order in the direction in which the radiation enters, are not to scale for the purpose of explanation.

The PC sheet 20 has a thickness of about 0.5 mm. The PC sheet 20 serves as a radiation receiving surface during imaging, and is formed integrally with a resin mold frame 40. Further, the surface on the radiation receiving side of the PC sheet 20 is matted to include multiple small projections 20A formed thereon.

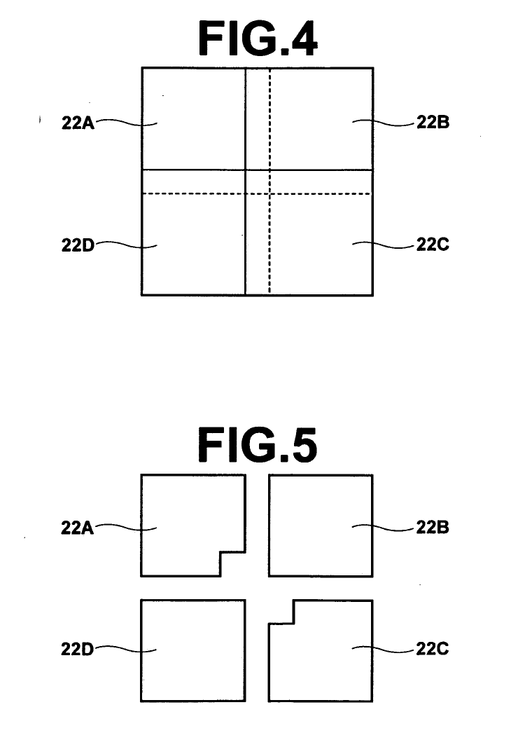

The graphite sheet 22 serves as a heat dissipating member, and is laminated on the PC sheet 20. The graphite sheet 22 has a thickness of about 50 μm, which provides a radiation absorptance of not more than 1%. Further, the heat more easily dissipates in the surface direction of the graphite sheet 22 than in the thickness direction thereof. Since the graphite sheet 22 is a brittle material, PET may be laminated on the surface the graphite sheet 22. Further, since it is difficult to produce a graphite sheet having a size large enough for imaging (for example, about 350 mm×450 mm, commercially available graphite sheets have a relatively small size. In this embodiment, four small-size graphite sheets 22A to 22D are arranged such that portions thereof overlap with each other, as shown in FIG. 4, and are laminated on the PC sheet 20 as the single graphite sheet 22.

It should be noted that, when the rectangular sheets 22A to 22D having the same size are arranged such that portions thereof overlap with each other, the central portion of the graphite sheet 22 has a thickness equal to the total thickness of four sheets. Therefore, as shown in FIG. 5, each of the two sheets 22A and 22C (or the sheets 22B and 22D) of the four sheets 22A to 22D, which are at diagonally opposite positions of the graphite sheet 22, may be provided with a cut-out portion at the position corresponding to the center of the graphite sheet 22, so that the thickness of the area where the sheets 22A to 22D overlap with each other is uniform throughout the graphite sheet 22, thereby preventing increase of the thickness at the central portion of the graphite sheet 22. Although the four small-size sheets 22A to 22D are used in this embodiment, any number of sheets having any size may be used depending on the size of the graphite sheet 22 and the size of the cassette 1.

Further, the graphite sheet 22 has a size larger than the size of an imaging area, where the radiation is actually detected for taking a radiographic image, of the imaging board 26. Specifically, the size of the graphite sheet 22 is larger than the imaging area for taking a radiographic image by 5 to 10 mm in each of upward, downward, leftward and rightward directions.

The carbon plate 24 serves as a strengthening member for strengthening the exterior of the housing 10. The reason of using the carbon plate 24 is that carbon transmits radiation and does not easily transmit electromagnetic waves other than radiation. Therefore, any other material that satisfies this condition (such as copper or stainless steel) may be used. The carbon plate 24 is connected to a reinforcing metal plate 42 made of copper or stainless steel, which is integrally formed in the resin mold frame 40. Further, a gasket 46 is disposed in the resin mold frame 40.

The imaging board 26 forms, together with the scintillator 28, an indirect-type FPD. The imaging board 26 is formed by a TFT panel, on which a photodiode, a capacitor and a TFT are mounted. The entire part of the imaging board 26 is bonded to the carbon plate 24 via an adhesive 48, such as a double-faced adhesive tape, to ensure the strength of the imaging board 26, and thus the imaging board 26 is disposed in close contact with the carbon plate 24. It should be noted that, while the strength can be ensured by bonding the entire part of the imaging board 26 to the carbon plate 24, this increases conduction of the body temperature of the subject to the imaging board 26. Therefore, the imaging board 26 may be bonded only partially to the carbon plate 24.

The scintillator 28 is made of a fluorescent material, such as CsI or GOS, and is laminated on the imaging board 26. When the radiation applied to the cassette 1 enters the scintillator 28, the scintillator 28 emits fluorescence. This fluorescence is detected by the imaging board 26 and is converted into an electric signal.

The foam material 30 is laminated on the scintillator 28, and serves as a heat insulator for preventing conduction of heat generated from the circuit boards 38A and 38B to the imaging board 26. The foam material 30 also serves as a buffer material for preventing a force applied to the back rid 36 during handling of the cassette 1 from acting on the imaging board 26 via the spacers 34A to 34C.

The base plate 32 serves to hold the imaging board 26, the scintillator 28 and the foam material 30 on the resin mold frame 40 together with the carbon plate 24, and shield the circuit boards 38A and 38B from x-ray. The base plate 32 is made of a metal, such as copper. End portions of the base plate 32 are secured to the reinforcing metal plate 42 via the carbon plate 24 with screws (not shown), together with an intermediate member 44 made of copper or stainless steel for attaching the back rid 36 to the resin mold frame 40.

The spacers 34A to 34C form a space between the base plate 32 and the back rid 36. In this space, the circuit boards 38A and 38B are disposed. The heat from the circuit boards 38A and 38B is once dissipated into this space, and then is dissipated to the outside via the back rid 36. The circuit boards 38A and 38B are connected to the imaging board 26 via wiring 46.

The back rid 36 is made of aluminum with an olefin sheet laminated thereon, and is secured to the intermediate member 44 with screws (not shown). The PC sheet 20, the resin mold frame 40 and the back rid 36 forms the housing 10.

During imaging using the cassette 1, the subject contacts the cassette 1, as shown in FIG. 2. In the case of the cassette 1 according to this embodiment, the subject contacts the PC sheet 20. Further, when the operator handles the cassette 1, the operator contacts the PC sheet 20. Since heat conductivity of PC is not so high, the heat conduction rate is reduced. As a result, the body temperature of the subject is less likely to be conducted into the housing 10 of the cassette 1. Further, since the surface of the PC sheet 20 is matted, a contact area between the subject and the PC sheet 20 is reduced. As a result, the body temperature of the subject or operator is even less likely to be conducted into the housing 10.

Even if the body temperature of the subject is conducted from the PC sheet 20 into the housing 10, the PC sheet 20 in this embodiment is provided with the graphite sheet 22 laminated thereon. Therefore, the heat is dissipated in the direction along the surface of the graphite sheet 22. Further, the graphite sheet 22 in this embodiment is formed by the small size sheets 22A to 22C. Since the small size sheets 22A to 22C overlap with each other, heat conductivity is not hindered between the individual sheets 22A to 22C. Therefore, temperature variation due to the body temperature of the subject or operator conducted from the PC sheet 20 to the imaging board 26 is eliminated, thereby preventing density variation of radiographic images obtained using the cassette 1.

The heat conducted from the PC sheet 20 into the housing 10 is dissipated via the graphite sheet 22. However, there is no escape for the heat at end portions of the graphite sheet 22, and the heat staying there may cause density variation of the radiographic images. In this embodiment, the graphite sheet 22 is provided with a size larger than the size of the imaging area for taking a radiographic image of the imaging board 26. Therefore, the end portions of the graphite sheet 22 are out of the imaging area. As a result, density variation of the radiographic images due to the heat staying at the end portions of the graphite sheet 22 can be prevented.

Further, by providing the graphite sheet 22 with a radiation absorptance of not more than 1%, reduction of the amount of radiation that is transmitted from the radiation receiving side to the rear side of the graphite sheet 22 during imaging can be prevented.

In the above-described embodiment, a copper or aluminum sheet may be used in place of the graphite sheet 22. In this case, the thickness of the copper or aluminum sheet may be determined to provide a radiation absorptance of not more than 1%.

Further, although the PC sheet 20 is laminated on the graphite sheet 22 in the above-described embodiment, the graphite sheet 22 may be disposed at any position between the PC sheet 20 and the imaging board 26. For example, the graphite sheet 22 may be disposed between the imaging board 26 and the carbon plate 24.

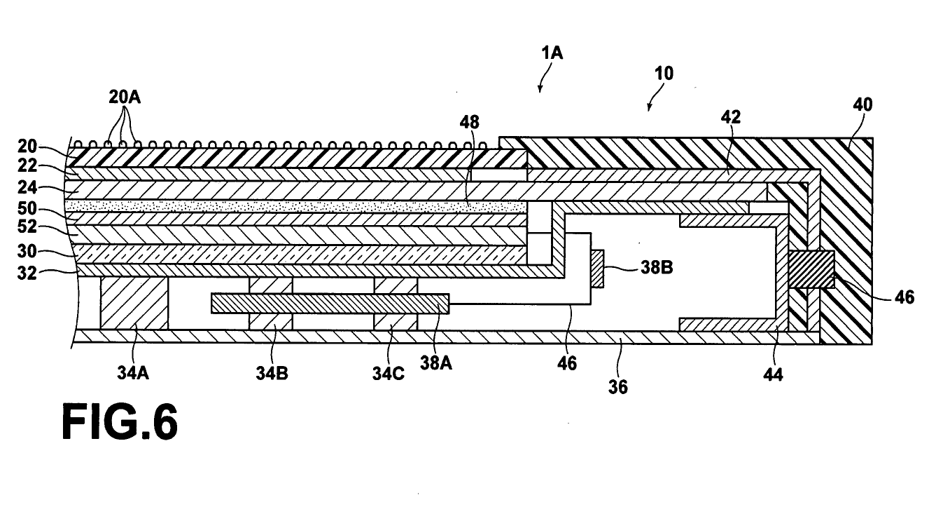

Still Further, although the cassette using an indirect-type FPD formed by the imaging board 26 and the scintillator 28 is described in the above-described embodiment, the present invention is also applicable to a cassette using a direct-type FPD. FIG. 6 is a partial sectional view illustrating the internal structure of a cassette according to another embodiment of the invention. Among the elements shown in FIG. 6, elements which are the same as those shown in FIG. 3 are denoted by the same reference numerals, and are not described in detail. A cassette 1A shown in FIG. 6 includes a photoconductive film 50, such as amorphous selenium, and an imaging board 52, such as a TFT panel, including a capacitor and a TFT mounted thereon, which form a direct-type FPD, in place of the imaging board 26 and the scintillator 28 of the cassette 1.

Even with the cassette 1A using the direct-type FPD, the graphite sheet 22 disposed on the radiation receiving side of the imaging board 52 prevents temperature variation across the imaging board 52 due to the body temperature of the subject or operator conducted from the PC sheet 20, thereby preventing density variation of radiographic images obtained with the cassette 1A.

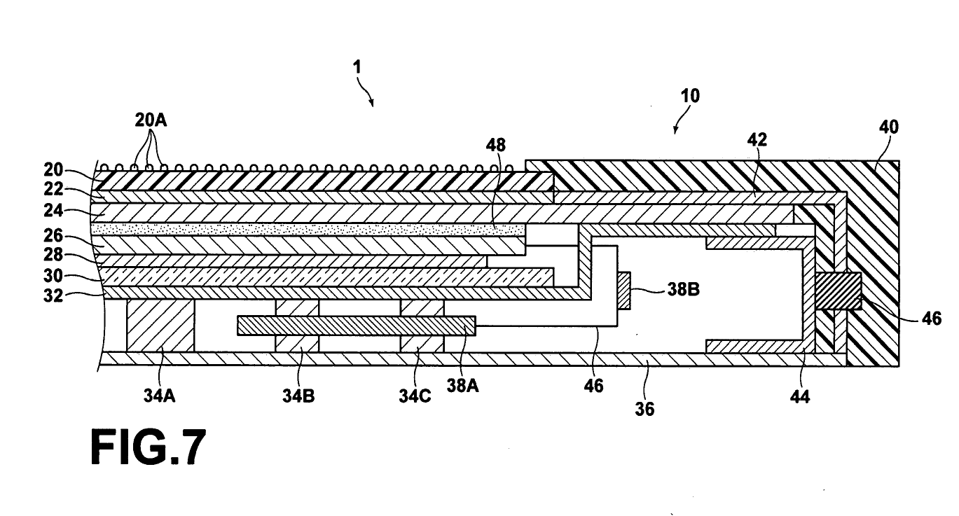

Further, as shown in FIG. 7, the graphite sheet 22 in the above-described embodiment may have a size larger than the size of the imaging board 26. With this, the size of the graphite sheet 22 can reliably be made larger than the size of the imaging area of the imaging board, where the radiation is actually detected to take a radiographic image.

Although the surface of the PC sheet 20 is matted in the above-described embodiment, the surface of the PC sheet 20 may not be matted.

Further, although the radiation detection device according to the invention is applied to a cassette in the above-described embodiment, the radiation detection device according to the invention is also applicable to a floor-standing type radiation imaging apparatus.

What is claimed is:

1. A radiation detection device including an imaging board for detecting radiation transmitted through a subject to obtain a radiographic image of the subject, the device comprising:
a heat dissipating member disposed on a radiation receiving side of the imaging board.

2. The radiation detection device as claimed in claim 1, wherein the heat dissipating member has a size larger than a size of an imaging area for taking the radiographic image of the imaging board.

3. The radiation detection device as claimed in claim 1, further comprising a sheet member disposed on the radiation receiving side of the imaging board, the sheet member comprising a material having lower heat conductivity than that of the heat dissipating member.

4. The radiation detection device as claimed in claim 1, wherein a surface of the sheet member on the radiation receiving side is matted.

5. The radiation detection device as claimed in claim 1, wherein the heat dissipating member has a radiation absorptance of not more than 1% with respect to the radiation.

6. The radiation detection device as claimed in claim 1, wherein heat conductivity in a direction parallel to a surface of the heat dissipating member is higher than heat conductivity in a direction perpendicular to the surface.

7. The radiation detection device as claimed in claim 1, wherein the heat dissipating member comprises a plurality of heat dissipating members, each of the plurality of heat dissipating members comprising portions overlapping with the other heat dissipating members.

8. The radiation detection device as claimed in claim 7, wherein the overlapping portions of the heat dissipating members are provided with a uniform thickness.

9. The radiation detection device as claimed in claim 1, further comprising a scintillator disposed on a side of the imaging board opposite from the radiation receiving side, the scintillator emitting fluorescent when the radiation is applied thereto.

10. The radiation detection device as claimed in claim 1, further comprising a platen disposed on the radiation receiving side, wherein the imaging board is disposed in close contact with the platen.
